(19) United States
(12) Patent Application Publication
(10) Pub. No.: US 2016/0022531 A1
(43) Pub. Date: Jan. 28, 2016

(54) STATIONARY SELF-MASSAGE APPARATUS FOR ATTACHMENT TO VARIOUS STABALIZING SURFACES

(71) Applicant: Ian Q. Ryan, San Francisco, CA (US)

(72) Inventor: Ian Q. Ryan, San Francisco, CA (US)

(21) Appl. No.: 14/859,231

(22) Filed: Sep. 18, 2015

Related U.S. Application Data
(63) Continuation-in-part of application No. 14/714,220, filed on May 15, 2015.
(60) Provisional application No. 61/993,472, filed on May 15, 2014.

(51) Int. Cl. A61H 15/00

(52) U.S. Cl. CPC A61H 15/0092; A61H 2015/0064; A61H 2201/0119

(57) ABSTRACT

A massage device for use on horizontal, vertical, narrow or non-flush stabilizing surfaces is disclosed. The massage device can include a frame having a cavity of a substantially half spherical shape to accommodate a roller ball. A plurality of ball bearings located between the cavity and the roller ball allow the roller ball to rotate as affected by motion from external forces of self-massaging, a massage from another person, or otherwise. A stabilizing mechanism attached to the frame provides stabilization during self-massage. The massage device attaches to horizontal or a vertical flush surface with suction cups, and to a non-flush surface or one that is narrower than the massage device with a strap.

### CROSS-REFERENCE TO RELATED APPLICATIONS

This application claims priority as a continuation-in-part to U.S. application Ser. No. 14/714,220, filed on May 15, 2015 by Ian Q. Ryan, which in turn claims the benefit of U.S. Provisional Application No. 61/993,472, filed on May 15, 2014, by Ian Q. Ryan, the content of both being incorporated herein by reference in their entirety.

### FIELD OF THE INVENTION

The invention relates generally to a massage device, and more specifically, to a massage device with a roller ball that remains stationary to various stabilizing surfaces during self-massage.

### BACKGROUND

Unattended muscle and joint pains can become chronic problems over time, which can lead to expensive treatments. Although some people receive massage therapies and physical therapies, these treatment options can be expensive and time consuming. Additionally, many conventional massage tools are ineffective and are not versatile. Therefore, there is a need in the prior art for a versatile device that can relieve muscle and joint pains that can be used at the convenience of the user.

Conventional self-massage devices are not capable of reaching many affected areas, for example, calf, hamstring, glute, back and shoulder muscles. Other conventional self-massage devices, such as foam rollers are not easily adapted to vertical surfaces and move along with a user. Many of these devices also require a flush surface with a large area which may not be readily accessible for users at work in an office or on an airplane, for instance.

What is needed is a robust self-massaging device that can adapt to various types of stabilizing surfaces.

### SUMMARY

The above-mentioned shortcomings are addressed by a device and method for massaging a user with a roller ball that moves in any direction while a frame holding the roller ball is stabilized in a stationary position against horizontal, vertical, non-flush or narrow surfaces.

A massage device can include a frame having a cavity of a substantially half spherical shape to accommodate a roller ball. In one embodiment, a plurality of ball bearings located between the cavity and the roller ball allow the roller ball to rotate as affected by motion from external forces of self-massaging, a massage from another person, or otherwise.

A stabilizing mechanism attached to the frame provides stabilization during self-massage. In one aspect, the massage device attaches to horizontal or a vertical flush surface with suction cups. In another aspect, the massage device attaches to a non-flush surface or one that is narrower than the massage device with a strap.

Many other embodiments are possible.

Advantageously, a user can self-apply massage treatments using stabilizing surfaces that are available at the time.

### BRIEF DESCRIPTION OF THE SEVERAL VIEWS OF THE DRAWINGS

In the following drawings, like reference numbers are used to refer to like elements. Although the following figures depict various examples of the invention, the invention is not limited to the examples depicted in the figures

FIGS. 1-3 show several views of a first massage device with suction cups, according to some embodiments.

FIGS. 4-7 show several views of a second massage device with suction cups, according to some embodiments.

FIGS. 8-9 show use cases of the first massage device against horizontal and vertical stabilizing surfaces, according to some embodiments.

FIGS. 10-11 show use cases of the second massage device against narrow and non-flush surfaces, according to some embodiments.

### DETAILED DESCRIPTION

A device and method for massaging a user with a roller ball that moves in any direction while a frame holding the roller ball is stabilized in a stationary position is disclosed. The following embodiments are set forth for the purposes of illustration only and are not intended to limit additional possible embodiments within the spirit of the present invention.

I. First Massage Device Embodiments

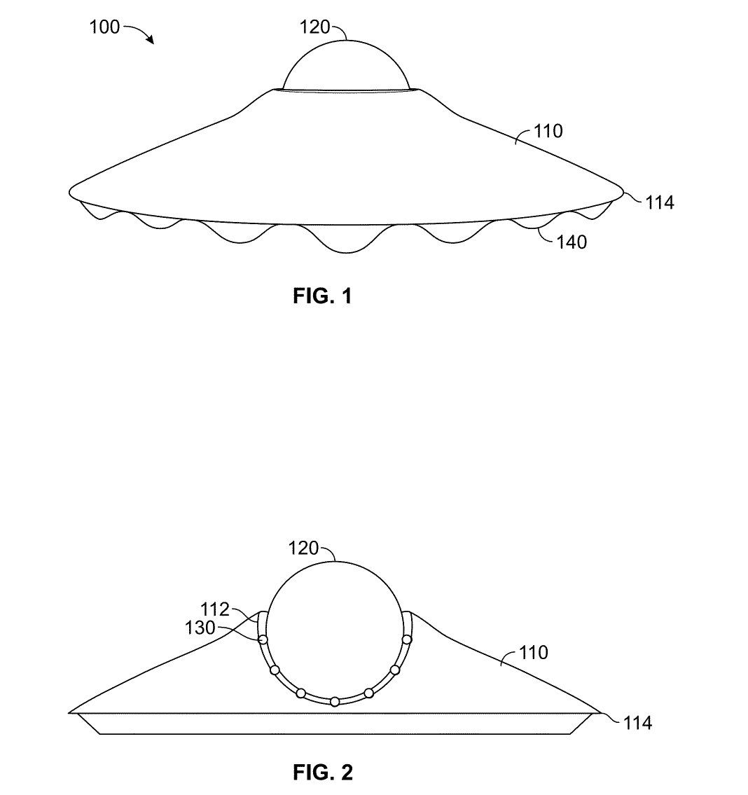

FIGS. 1-3 are schematic diagrams illustrating a massage device 100, according to some embodiments. The massage device 100 includes a frame 110, a roller ball 120, ball bearings 130 and stabilizing mechanism 140.

The frame (or housing) 110 is saucer shaped but can be square, oval, rectangular, or the like. The frame 110 includes a cavity 112 having size and shape appropriate for the roller ball 120. For example, the cavity 112 can be approximately a half sphere of about 180 degrees. In one embodiment, as shown in the section view of FIG. 2, the cavity 112 is slightly larger than 180 degrees to prevent the roller ball 120 from falling out. In another embodiment, lips of the cavity 112 can be pulled back to release the roller ball 120 for cleaning or replacement. The frame 110 also includes a base 114 that can be wider than, and tapered towards, the cavity 112 in order to stabilize the massage device 110. The frame 110 can be modified to accommodate handles although the present embodiment does not show any.

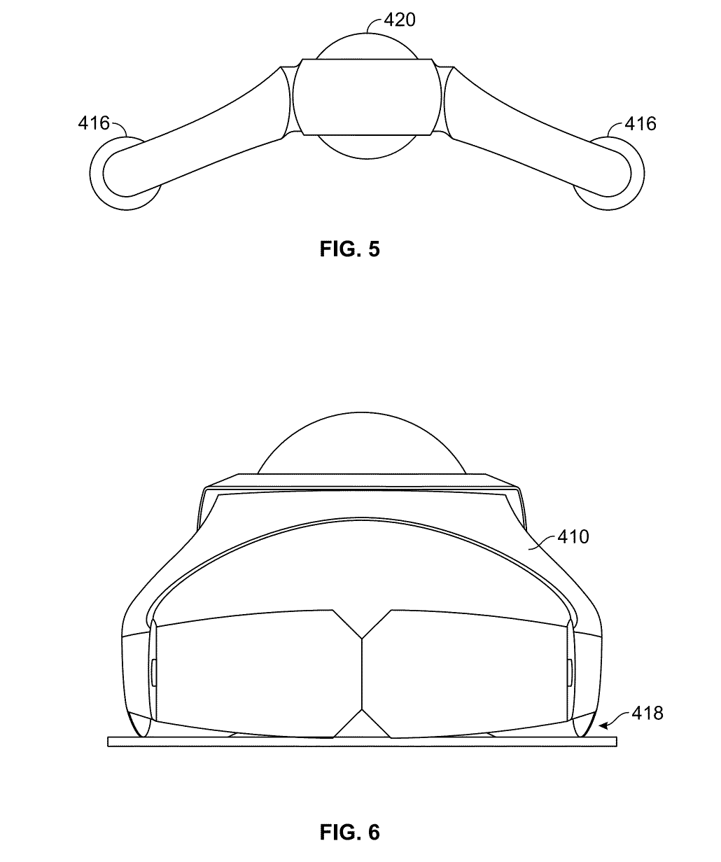

The frame 110 can be formed from plastic, rubber, steel, or any combination of appropriate materials. The frame shape is non-limiting in and of itself as any frame capable of partially exposing roller balls for self-massaging is contemplated. For example, a different frame with different features is discussed below with respect to FIGS. 4-7.

The roller ball 120 fits within the cavity 112 resting on the ball bearings 130 for movement. Movement is primarily along two dimensions, and can be restricted to only straight lines along an x- or y-axis, or can be free moving between any points over a two dimensional plane. There can also be relatively slighter movement over a z-axis to allow the massing device 110 to absorb the weight of body part pressure by allowing the roller ball 120 to depress into the frame 110. Additionally, the massage device 100 an be implemented to push into a body part for more pressure, along the opposite directly of the z-axis.

The roller ball 120 can be made of plastic, rubber, metal or any combination of appropriate materials of various durometers. The roller ball 120 can be solid or hollow. In one embodiment, the roller ball 120 is firm enough to provide sufficient force for massaging muscles of legs and arms (e.g., comparable to a pool table ball). In another embodiment, the roller ball 120 is not as firm for a more gentle massage (e.g., comparable to a tennis ball firmness).

An embodiment of the roller ball 120 applies electrically generated heat or warms up during use and can provide electrical stimulation. Another embodiment of the roller ball 120 vibrates or pulses. Lights or aesthetic features can be included. Other embodiments have several roller balls in various configurations. Alternative roller balls can have a much smaller or larger proportional size relative to frames (e.g. size can be comparable to marbles, ping pong balls, or a bowling ball).

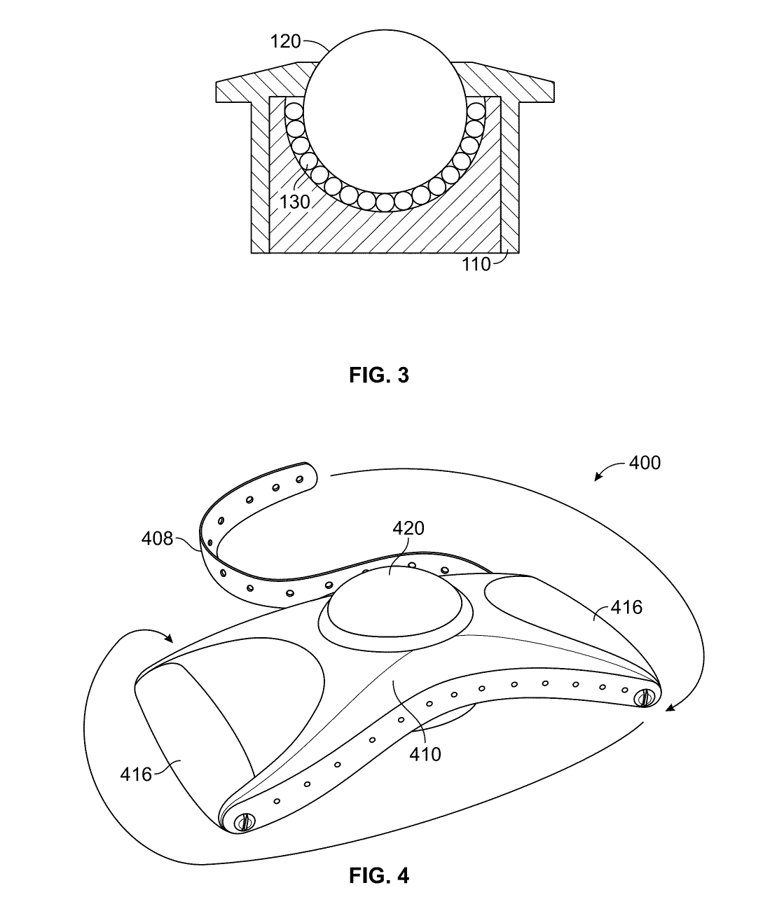

The ball bearings 130 allow the roller ball 120 to rotate in any direction when affected by an external force, such as a self-messaging user. In FIG. 2, a configuration of balls in the ball bearings 130 follows a shape of the cavity 112. The balls are smaller relative to the roller ball 120 and can be spaced tightly as in FIG. 3 or more loosely as in FIG. 2, depending on a specific implementation. The ball bearings 130 can be composed of plastic, rubber, metal, or any combination of appropriate materials.

The stabilizing mechanism 140 can be of many forms. Suction cups paced around a base of the frame 110 keep the massage device 100 stationary, during periods of non-use and periods of massaging. One aspect spaces the suction cups evenly around a base perimeter, such as two suction cups on opposing ends, or three suction cups at 120 degree spacing between each other. Additional types of stabilizing mechanisms are contemplated and another example is given below.

II. Second Massage Device Embodiments

FIGS. 4-7 are schematic diagrams illustrating a massage device 400, according to different embodiments. The massage device 400 includes a frame 410, a roller ball 420, ball bearings (not shown), and stabilizing mechanism 408.

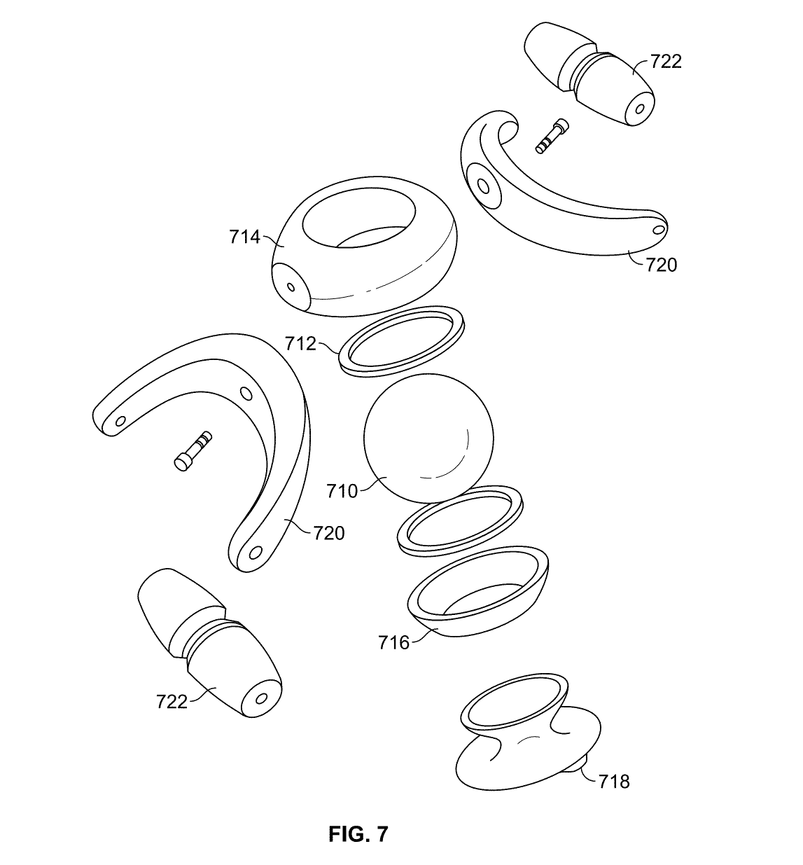

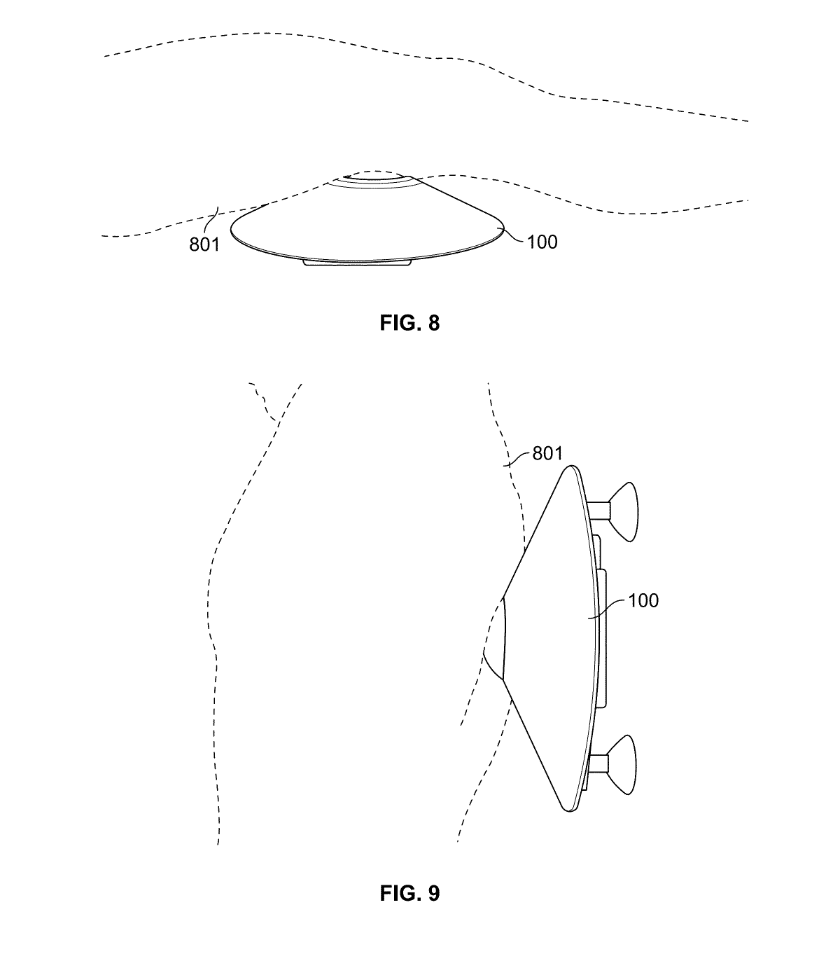

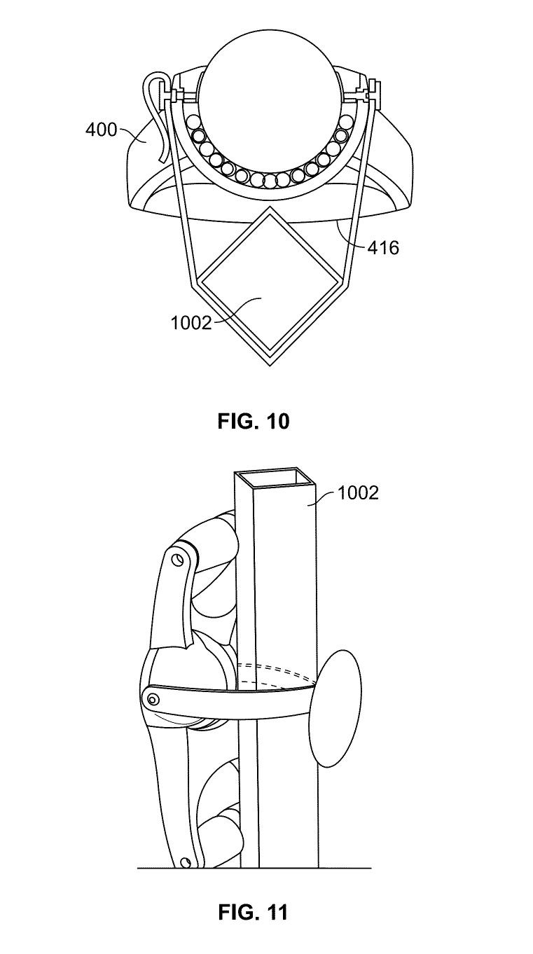

The frame 410 in this case is generally a rectangular shape with cutouts for handles 416 and a concave downward orientation. In one embodiment, the handles 416 allow a user to grip the massage device 400 and move around areas of the body when used in a non-stationary manner, as described in more detail below. In another embodiment, the handles 416 serve a second purpose of further stabilizing the massage device 400 when used in a stationary manner, also described in more detail below. The handles 416 can be connected to the frame 410 by a rigid member (e.g., metal or plastic) and made more comfortable by an outer softer surface (e.g., foam or rubber). In FIG. 6, lips 418 are included in the frame 410 to stabilize the massage device 400 on a flat surface from imbalance introduced by the handles 416.

The roller ball 420 is lodged within a cavity (not shown) located approximately center of the frame 410. The roller ball 420 in some embodiments exposes the ball on more than on side. As a result, the massage device 400 can be flipped over for varying types of pressure.

The stabilizing mechanism 408 of FIG. 4 includes a strap. In one case, the strap has holes for looping around a stabilizing surface and looping back into a buckle. In another case, a Velcro attachment or other suitable affixation is utilized. Other cases can include the strap and suction cups. As discussed, the handles 416 and frame lips can also be considered part of or an extension of the stabilizing mechanism 408.

FIG. 7 shows an exploded view of parts attached to the frame 410, according to an embodiment. A roller ball 710 is set into rings 712 and holders 714, 716, 718 which attach to the frame 410 for exposing portions of the roller ball 710 to massage a user. Handles 720 are attached to the frame 410 (alternatively can be a single mold with the frame 410) along with grips 722.

III. Methods of Using First and Second Massage Devices

Massage devices 100, 400 are preferably used for one person massaging another person, for self-massage, or other beneficial uses. Massage devices 100, 400 can be secured in a stationary position, or moved around different parts of the subject. Moreover, massage devices 100, 400 can be attached to stabilizing surfaces of various orientations and stabilizing surfaces that are not flush.

In a first use case of self-massaging on a stabilizing surface, the massage device 100 is attached horizontally to a floor or other solid surface with suction cups used as the stabilizing mechanism 140. This allows a user 801 to move back and forth over the roller ball 120 to treat hamstring, calf and other hard to reach areas. The roller ball 120 can be firmer than a foam roller and also remain stationary.

In another use case, the massage device 100 is attached vertically to a stabilizing surface, such as a wall or refrigerator. The vertical orientation can be used to reach back or shoulder muscles of the user 801, for example. A user's dynamic motion can be mostly vertical while maintaining a constant horizontal pressure into the massage device 100. Also, the section cups can have legs with springs which allow for horizontal movement even when vertically oriented.

In yet another use case, the massage device 400 is attached vertically to a narrow stabilizing surface 1002 such as bed post or a metal pole by a strap of other mechanism. Additionally, the grips 416 provide additional surface area to further stabilize the massage device 400 against a traditionally non-useable stabilizing surface.

IV. General Aspects of the Disclosure

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. An apparatus for self-massaging, comprising:
a frame having a cavity of a substantially half spherical shape;
a roller ball having a spherical shape and located within the cavity, the roller ball for contact by body parts being massaged by a portion of the roller ball that is not within the cavity;
a plurality of ball bearings located between the cavity and the roller ball and sized smaller than the roller ball, the plurality of ball bearings allowing the roller ball to rotate as affected by motion from external forces; and
a stabilizing mechanism attached to the frame to stabilize the frame and keep the frame stationary when affected by motion from the external forces.

2. The apparatus of claim 1, wherein:
the roller ball rotates in any direction as affected by motion from external forces.

3. The apparatus for claim 1, wherein: the frame cavity secures the roller ball within the frame while also allowing rotation.

4. The apparatus for claim 1, wherein:
the stabilizing mechanism comprises at least one suction cup for temporary attachment to a stabilizing surface at any orientation.

5. The apparatus of claim 1, wherein:
the stabilizing mechanism comprises a strap for temporary attachment to a stabilizing surface.

6. The apparatus of clam 1, further comprising:
handles attached to the frame for movement of the massage apparatus by a user during a massage.

7. The apparatus of claim 1, further comprising:
handles attached to the frame attached to the frame for movement of the massage apparatus by a user during a massage, and also to further stabilize the massage apparatus when held stationary by the stabilizing mechanism.

8. The apparatus of claim 1, wherein: the frame is shaped in a concave down shape.

9. The apparatus of claim 1, wherein:
the stabilizing mechanism is secured to a stabilizing surface to remain stationary against vertical movement by a user.

10. The apparatus of claim 1, wherein:
the stabilizing mechanism is secured to a stabilizing surface to remain stationary against vertical movement by a user.

11. The apparatus of claim 1, wherein:
the stabilizing mechanism is secured to a stabilizing surface that is not flush to remain stationary against vertical movement by a user.

12. The apparatus of claim 1, wherein:
the stabilizing mechanism is secured to a stabilizing surface that is not flush to remain stationary against vertical movement by a user, wherein the stabilizing surface comprises a corner of a vertical post or pole.

13. The apparatus of claim 1, wherein:
the stabilizing surface is more narrow that the apparatus.
